(19) United States
(12) Patent Application Publication
(10) Pub. No.: US 2024/0052943 A1
(43) Pub. Date: Feb. 15, 2024

(54) APPARATUS HAVING VALVES ACTUATED BY MAGNETS

(71) Applicant: Hewlett-Packard Development Company, L.P., Spring, TX (US)

(72) Inventors: Kenneth Williams, Vancouver, WA (US); Keaton Oliver, Vancouver, WA (US); Jeffery S. Mathena, Vancouver, WA (US); Vem Elliot Myers, Vancouver, WA (US)

(21) Appl. No.: 17/766,312

(22) PCT Filed: Oct. 30, 2019
(86) PCT No.: PCT/US19/58738

§ 371 Date: Apr. 4, 2022

(51) Int. Cl. F16K 31/08; B41J 2/175

(52) U.S. Cl. CPC F16K 31/086; B41J 2/17596; B41J 2/17553

(57) ABSTRACT

In some examples, an apparatus can include a plunder comprising a cavity, a bezel comprising an aperture having a particular shape, a magnet located in the cavity of the plunger, and a magnetically actuated valve connected to the bezel, where in response to the plunger being moved by a key having a shape corresponding to the particular shape of the aperture of the bezel, the magnet is to cause the magnetically actuated valve to actuate.

### BACKGROUND

Imaging systems, such as printers, copiers, etc., may be used to form markings on a physical medium, such as text, images, etc. In some examples, imaging systems may form markings on the physical medium by performing a print job. A print job can include forming markings such as text and/or images by transferring a print fluid (e.g., ink, toner, etc.) to the physical medium.

### BRIEF DESCRIPTION OF THE DRAWINGS

FIG. 1 is a perspective view of an example of an apparatus having valves actuated by magnets consistent with the disclosure.

FIG. 2 is a top view of an example of an apparatus having valves actuated by magnets consistent with the disclosure.

FIG. 3 is a partial exploded view of an example of an apparatus having valves actuated by magnets consistent with the disclosure.

FIG. 4 is a perspective view of an example of an apparatus having valves actuated by magnets and a key consistent with the disclosure.

FIG. 5 is a perspective view of an example of an apparatus having valves actuated by magnets showing an aperture of a bezel consistent with the disclosure.

FIG. 6 is a perspective view of an example of an apparatus having valves actuated by magnets having a plunger in a second position consistent with the disclosure.

FIG. 7 is a perspective view of a system having valves actuated by magnets and a print fluid supply cartridge consistent with the disclosure.

### DETAILED DESCRIPTION

Imaging devices may include a supply of a print fluid located in a print fluid supply cartridge. As used herein, the term “print fluid” refers to a substance which can be transported through and/or utilized by an imaging device. In some examples, print fluid can be, for instance, a material such as ink that when applied to a medium, can form representation(s) (e.g., text, images, models, etc) on the medium during a print job, can be a material for three-dimensional (3D) printing, among other examples. In some examples, print fluid can be, for instance, cleaning fluids, fluids for chemical analysis, fluids to be included during transportation of the imaging device (e.g., shipping to a customer), etc.

The print fluid can be deposited onto a physical medium. As used herein, the term “imaging device” refers to any hardware device with functionalities to physically produce representation(s) (e.g., text, images, models, etc.) on the medium. In some examples, a “medium” may include paper, photopolymers, plastics, composite, metal, wood, or the like.

The print fluid supply cartridge including the print fluid may interface with the imaging device and include a supply of the print fluid such that the print fluid may be drawn from the print fluid supply cartridge as the imaging device creates the images on the print medium. As used herein, the term “print fluid supply cartridge” refers to a container, a tank, and/or a similar vessel to store a supply of the print fluid for use by the imaging device. In some examples, the print fluid supply cartridge can provide print fluid directly to a print head of the imaging device. In some examples, the print fluid supply cartridge can supply print fluid to a print fluid reservoir which can provide print fluid to a print head of the imaging device.

As the print fluid is provided to the imaging device via the print fluid supply cartridge (e.g., directly to a print head or to a reservoir), the amount of print fluid in the print fluid supply cartridge may deplete. As a result, the amount of print fluid in the print fluid supply cartridge of the imaging device may have to be replenished.

A print fluid supply cartridge may be filled, replaced, etc. In some examples, the print fluid supply cartridge may supply print fluid to a reservoir and be removed. In some examples, the print fluid supply cartridge may be interfaced with the imaging device and reside in the imaging device to provide print fluid when appropriate. Accordingly, a valve system may be utilized to prevent print fluid in the imaging device from leaking, losing pressure, etc. The valve system may include a valve that can be opened when the print fluid supply cartridge is attached to the imaging device. However, a user may intentionally or inadvertently cause the valve to be actuated (e.g., by using a dowel, pin, poker, their finger, etc.), which can lead to loss of pressure in the imaging device, print fluid leaking, etc.

An apparatus having valves actuated by magnets, according to the disclosure, can allow for actuation of a valve. In some examples, a magnet can be included with a plunger which may be depressed by a key. The key can include a unique shape such that the key can depress the plunger, but other mechanisms such as a dowel, pin, poker, a users finger, etc. may not depress the plunger. Accordingly, preventing unintentional depression of the plunger can prevent the valve from being actuated, which can prevent pressure loss in the imaging device, leaking of print fluid, etc.

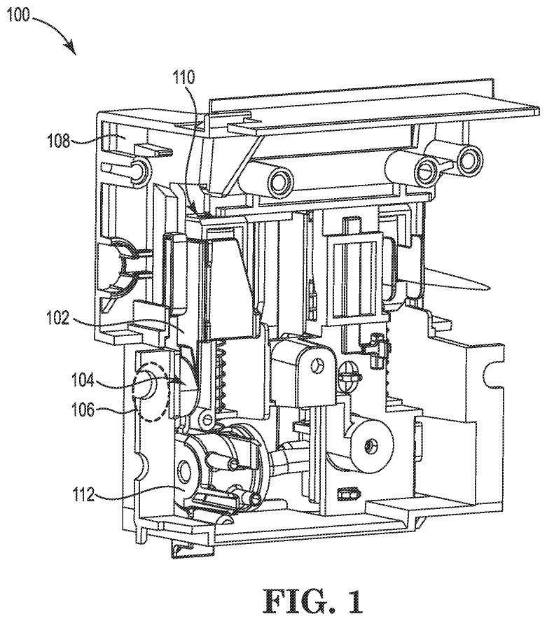

FIG. 1 is a perspective view of an example of an apparatus 100 having valves actuated by magnets consistent with the disclosure. Apparatus 100 can include a plunger 102, a bezel 108, and a magnetically actuated valve 112. The plunger 102 can include a cavity 104 having a magnet 106. The bezel 108 can include an aperture 110.

As illustrated in FIG. 1, the apparatus 100 can include a plunger 102. As used herein, the term “plunger” refers to a structure that is translatable in response to an applied force. For example, the plunger 102 can translate up and/or down (e.g., as oriented in FIG. 1) in response to a force on the plunger (e.g., by a key and/or by a spring).

The plunger 102 can include a cavity 104. As used herein, the term “cavity” refers to a hollow space within a structure. For example, the cavity 104 can be a hollow space within the plunger 102. As illustrated in FIG. 1, the cavity 104 is a cylindrical shape. However, examples of the disclosure are not so limited. For example, the cavity 104 can be any other shape.

The apparatus 100 can include a bezel 108. As used herein, the term “bezel” refers to a structural component of a system to which other components of the system are attached. For example, the bezel 108 can be a structural component of the apparatus 100. The plunger 102, magnetically actuated valve 112, and/or other components of the apparatus 100 may be attached to the bezel 108.

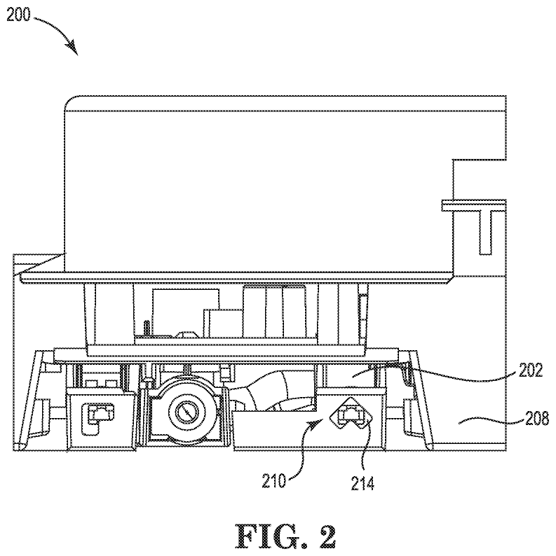

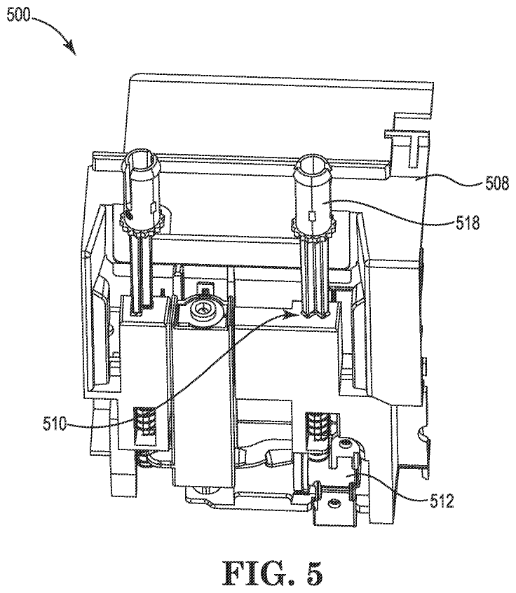

The bezel 108 can include an aperture 110. As used herein, the term “aperture” refers to an opening in a piece of material. For example, the aperture 110 can be an opening through the bezel 108 and can include a particular shape, as is further described in connection with FIGS. 2 and 5.

The cavity 104 of the plunger 102 can include a magnet 106. As used herein, the term “magnet” refers to an object that produces a magnetic field. For example, the magnet 106 can produce a magnetic field that may interact with other objects, including the magnetically actuated valve 112 as is further described herein. The magnet 106 (e.g., illustrated in FIG. 1 by the dashed line) can be located in the cavity 104 of the plunger 102. For example, the magnet 106 can be cylindrically shaped such that the magnet 106 can be located in the cylindrically shaped cavity 104 of the plunger 102. However, examples of the disclosure are not so limited. For example, as described above, the cavity 104 can be any other shape (e.g., square, rectangular, triangular, etc.) and the magnet 106 can be similarly shaped in order to be located in the cavity 104 of the plunger 102.

The apparatus 100 can include a magnetically actuated valve 112. As used herein, the term “magnetically actuated valve” refers to a device that regulates the flow of a fluid by opening, closing, or partially obstructing a passageway via magnetic actuation. For example, the magnetically actuated valve 112 can regulate the flow of print fluid through the magnetically actuated valve 112 by actuating the valve via the presence or absence of a magnetic field, as is further described herein.

The magnetically actuated valve 112 can be a normally closed valve. As used herein, the term “normally closed valve” refers to a valve which prevents the flow of a fluid by being closed until acted upon by an external input. For example, the magnetically actuated valve 112 can be normally closed until acted upon by an external input. The input can be, for instance, the presence of a magnetic field provided by the magnet 106, as is further described herein.

Although the plunger 102 is described above and illustrated in FIG. 1 as including a cavity 104 housing the magnet 106, examples of the disclosure are not so limited. For example, the cavity 104 can include a material (e.g., iron or other material) and the magnetically actuated valve 112 can include a magnet such that the material included in the cavity 104 of the plunger 102 can cause actuation of the magnetically actuated valve 112 when the material is located adjacent to the magnetically actuated valve 112.

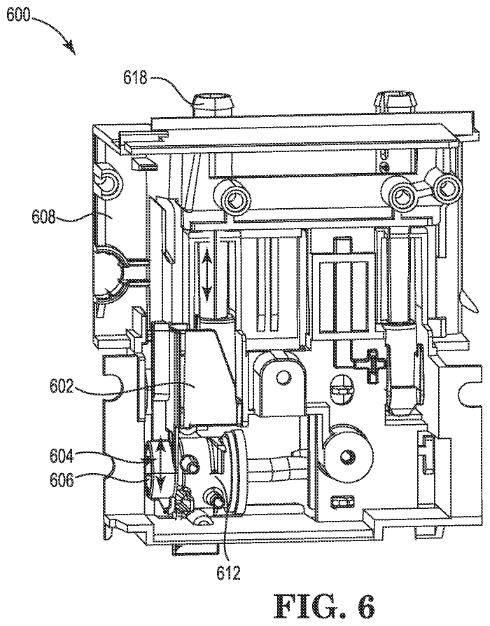

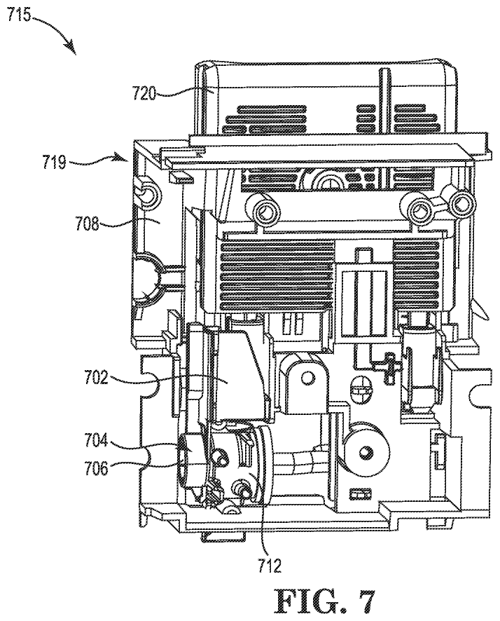

The magnet 106 can cause the magnetically actuated valve 112 to actuate. For instance, the plunger 102 can be moved from a first position (e.g., as illustrated in FIG. 1) to a second position (e.g., as is illustrated in and further described in FIGS. 6 and 7). In response to the plunger 102 being moved by a key (e.g., not illustrated in FIG. 1) having a shape corresponding to the particular shape of the aperture 110 of the bezel 108, the magnet can be located adjacent to the magnetically actuated valve 112 to actuate the magnetically actuated valve.

FIG. 2 is a top view of an example of an apparatus 200 having valves actuated by magnets consistent with the disclosure. Apparatus 200 can include a plunger 202 and a bezel 208. The plunger 202 can include a key surface 214. The bezel 208 can include the aperture 210.

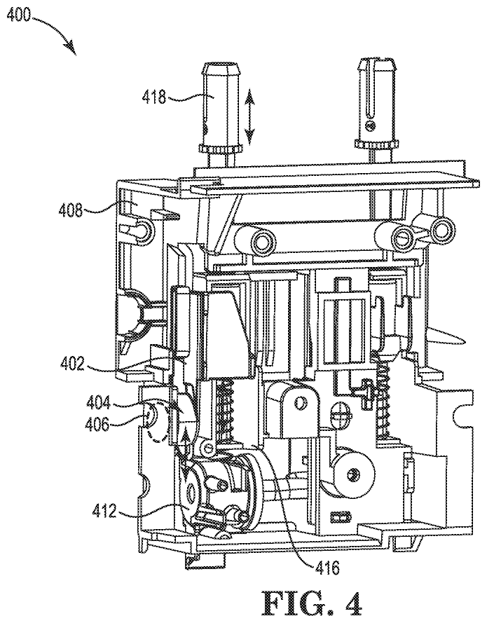

The plunger 202 can include a plurality of surfaces. One of the plurality of surfaces of the plunger 202 can be a key surface 214. As used herein, the term “key surface” refers to a surface with which a key can contact to cause the plunger 202 to move from a first position to a second position. For example, a key (e.g., not illustrated in FIG. 2 but is further described in connection with FIGS. 4-6) can contact the key surface 214 to depress the plunger 202 from the first position to the second position such that the magnet of the plunger 202 can be located adjacent to the magnetically actuated valve.

The bezel 208 can cover the plurality of surfaces of the plunger 202. However, as was previously described in connection with FIG. 1, the bezel 208 can include the aperture 210. The aperture 210 can include a particular shape which can expose a portion of the key surface 214 of the plunger 202.

As illustrated in FIG. 2, the portion of the key surface 214 which is exposed (e.g., not covered) by the bezel 208 can be a small amount of the key surface 214 that is visible through the aperture 210. By selecting the shape of the aperture 210 to show a small amount of the key surface 214, the small amount of visible key surface 214 can increase the difficulty of depressing the plunger 202 by an object other than using a key having a shape corresponding to the shape of the aperture 210.

As illustrated in FIG. 2, the aperture 210 can be a chevron shape. For example, the aperture 210 can be an inverted “V” shape (e.g., as oriented and illustrated in FIG. 2).

However, examples of the disclosure are not so limited. For example, the aperture 210 can be a square shape, a round shape, a triangular shape, a diamond shape, and/or any other shape which can expose a portion of the key surface 214 of the plunger 202 such that a key can contact the plunger 202 to move the plunger from the first position to a second position.

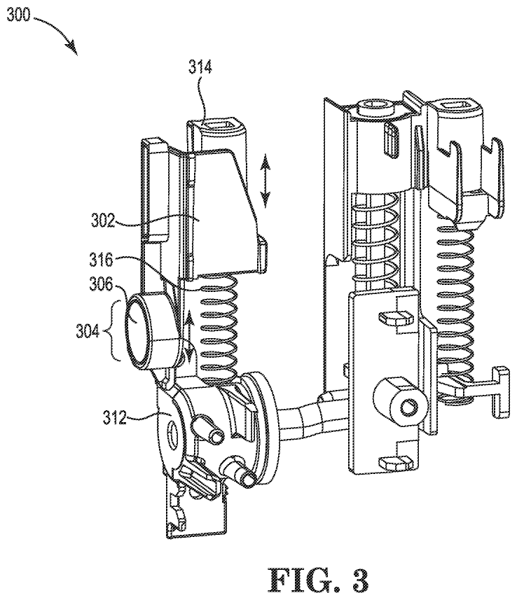

FIG. 3 is a partial exploded view of an example of an apparatus 300 having valves actuated by magnets consistent with the disclosure. Apparatus 300 can include a plunger 302, a magnetically actuated valve 312, and a spring 316. The plunger 302 can include a cavity 304 having a magnet 306. The apparatus 300 is illustrated in FIG. 3 without the bezel (e.g., bezel 108, 208, previously described in connection with FIGS. 1 and 2, respectively).

The apparatus 300 can include a spring 316. As used herein, the term “spring” refers to a mechanical device that stores energy. For example, the spring 316 can be a coil spring. However, examples of the disclosure are not so limited to a coil spring. For example, the spring 316 can be a flat spring, cantilever spring, among other types of springs.

Although the apparatus 300 is described above as including a spring, examples of the disclosure are not so limited. For example, the apparatus 300 can include a biasing member to bias the plunger 302 in the first position.

The spring 316 can be connected to the plunger 302 such that the plunger 302 is normally in the first position (e.g., as illustrated in FIG. 3). For example, the spring 316 can be in a resting position (e.g., spring 316 is not compressed) such that the plunger 302 is normally in the first position (e.g., the magnet is not located adjacent to the magnetically actuated valve 312).

FIG. 4 is a perspective view of an example of an apparatus 400 having valves actuated by magnets and a key consistent with the disclosure. Apparatus 400 can include a plunger 402, a bezel 408, a magnetically actuated valve 412, a spring 416, and a key 418. The plunger 402 can include a cavity 404 having a magnet 406.

As illustrated in FIG. 4, the apparatus 400 can include a plunger 402. The plunger 402 can include the cavity 404 having the magnet 406. As illustrated in FIG. 4, the plunger 402 can be in a first position. In the first position, the spring 416 can be in a resting position (e.g., the spring 416 is not compressed) and as a result, the magnet 406 is not located adjacent to the magnetically actuated valve 412. As a result, the magnetically actuated valve 412 remains normally closed.

As previously described in connection with FIG. 2, the bezel 408 can include an aperture having a particular shape (e.g., a chevron shape. although examples of the disclosure are not limited to a chevron shape). The aperture can expose a portion of the key surface of the plunger 402.

The apparatus 400 can include a key 418. As used herein, the term “key” refers to a protruding device having a unique shape that, when received by a mechanism to designed to receive the uniquely shaped protruding device, allows an action to occur. For example, the key 418 can include a uniquely shaped protrusion that can be received by the particularly shaped aperture of the bezel 408, as is further described in connection with FIG. 5. The action can be, for example, causing the plunger 402 to be depressed from a first position (e.g., as illustrated in FIG. 4) to a second position (e.g., as illustrated in FIGS. 6 and 7).

FIG. 5 is a perspective view of an example of an apparatus 500 having valves actuated by magnets showing an aperture of a bezel consistent with the disclosure. Apparatus 500 can include a bezel 508, a magnetically actuated valve 512, and a key 518. The bezel 508 can include the aperture 510.

As previously described in connection with FIG. 4, the apparatus 500 can include a key 518. The key 518 can be included in a print fluid supply cartridge (e.g., not illustrated in FIG. 5). The print fluid supply cartridge can interface with the bezel 508 in order to supply print fluid to an imaging device, as is further described in connection with FIG. 7.

As illustrated in FIG. 5, the key 518 can include a uniquely shaped protrusion. The uniquely shaped protrusion can be a shape such that it can be received by the uniquely shaped aperture 510. For example, the aperture 510 can be a chevron shape, and the uniquely shaped protrusion of the key 518 can include a complimentary chevron shape such that the key 518 can be received by the aperture 510.

However, examples of the disclosure are not so limited. For example, the aperture 510 can be a square shape, a round shape, a triangular shape, a diamond shape, etc., and the key 518 can be a square shape, a round shape, a triangular shape, a diamond shape, respectively such that the key 518 can be received by the aperture 510.

When the key 518 is inserted through the aperture 510, the key 518 can contact the key surface of the plunger. The key 518 can cause the plunger to be moved from the first position to the second position, as is further described in connection with FIG. 6.

FIG. 6 is a perspective view of an example of an apparatus 600 having valves actuated by magnets having a plunger in a second position consistent with the disclosure. Apparatus 600 can include a plunger 602, a bezel 608, a magnetically actuated valve 612, and a key 618. The plunger 602 can include a cavity 604 having a magnet 606.

As illustrated in FIG. 6, the key 618 can be inserted through the aperture of the bezel 608 to cause the plunger 602 to move from the first position to the second position (e.g., as illustrated in FIG. 6). Although not illustrated in FIG. 6, the apparatus 600 can include a spring (e.g., spring 316, 416, previously described in connection with FIGS. 3 and 4, respectively). As a result of the key 618 depressing the plunger 602, the spring can be in a compressed state while the plunger 602 is in the second position.

As a result of the plunger 602 moving to the second position, the cavity 604 of the plunger 602 can be oriented such that the magnet 606 can be located adjacent to the magnetically actuated valve 612 in response to the plunger 602 being in the second position. For example, the plunger 602 can translate linearly downwards (e.g., as oriented in FIG. 6) as a result of the key 618 depressing the plunger 602 such that the cavity 604 having the magnet 606 is oriented adjacent to the magnetically actuated valve 612.

As described above, the magnet 606 can generate a magnetic field. When the magnet 606 is adjacent to the magnetically actuated valve 612, the magnetically actuated valve 612 can actuate from normally closed to open as a result of the magnetic field generated by the magnet 606.

In some examples, as previously described in connection with FIG. 1, the cavity 604 can include a material and the magnetically actuated valve 612 can include a magnet. The magnet included in the magnetically actuated valve 612 can generate a magnetic field and when the material in the cavity 604 is adjacent to the magnetically actuated valve 612, the magnetically actuated valve 612 can actuate from normally closed to open.

FIG. 7 is a perspective view of an example of a system 715 having valves actuated by magnets and a print fluid supply cartridge 720 consistent with the disclosure. The system 715 can include a key assembly 719 and a print fluid supply cartridge 720. The key assembly 710 can include a plunger 702, a bezel 708, and a magnetically actuated valve 712. The plunger 702 can include a cavity 704 having a magnet 706.

As illustrated in FIG. 7, the system 715 can include a key assembly 719. As used herein, the term “key assembly” refers to a collection of devices oriented such that an action is taken when a key is received. For example, the key assembly 719 can include the plunger 702 connected to a spring (e.g., not illustrated in FIG. 7), where the plunger includes a key surface (e.g., not illustrated in FIG. 7) and a cavity 704, a bezel 708 including an aperture, a magnet 706 located in the cavity 704 of the plunger 702, and a magnetically actuated valve 712.

As previously described in connection with FIGS. 2 and 5, the aperture of the bezel 708 can include a particular shape. For example, the aperture of the bezel 708 can include a chevron shape which exposes a portion of the key surface of the plunger 702.

The system 715 can include the print fluid supply cartridge 720. The print fluid supply cartridge 720 can include print fluid. For example, a supply of print fluid to an imaging device may have to be replenished in order to complete print jobs. The print fluid supply cartridge 720 can accordingly interface with the key assembly 719, as is further described herein.

The print fluid supply cartridge 720 can include at least one key (e.g., key 418, 518, 618, previously described in connection with FIGS. 4-6, respectively). The key can include a shape (e.g., a chevron shape) corresponding to the shape of the aperture of the bezel 708.

The print fluid supply cartridge 720 can interface with the key assembly 719 such that the key is to be inserted through the aperture of the bezel 708. The key can contact the key surface of the plunger 702 when inserted through the aperture of the bezel 708 such that the plunger 702 can move from the first position to the second position (e.g., as illustrated in FIG. 7). Moving the plunger 702 from the first position to the second position can cause the spring (e.g., not illustrated in FIG. 7) to compress.

In response to the plunger 702 being moved from the first position to the second position by the key of the print fluid supply cartridge 720, the magnet 706 can be positioned adjacent to the magnetically actuated valve 712. The magnetic field generated by the magnet 706 can cause the magnetically actuated valve 712 to actuate from normally closed to open.

Actuation of the magnetically actuated valve 712 from normally closed to open can cause print fluid to be supplied from the print fluid supply cartridge 720 to a print fluid reservoir of the imaging device via the magnetically actuated valve 712. Accordingly, the imaging device is able to utilize the supplied print fluid to complete a print job.

In some examples, the print fluid supply cartridge 720 can be removed in order to refill and/or replace the print fluid supply cartridge 720. Accordingly, the print fluid supply cartridge 720 can be removed from the key assembly 719.

In response to the print fluid supply cartridge 720 being removed from the key assembly 719, the spring can decompress. Decompression of the spring can cause the plunger 702 to move from the second position to the first position. As a result of the plunger 702 moving from the second position to the first position, the cavity 704 having the magnet 706 can translate away from the magnetically actuated valve 712. As a result, the magnet 706 is no longer adjacent to the magnetically actuated valve 712, and the magnetically actuated valve 712 no longer is in the presence of the magnetic field generated by the magnet 706 and can actuate from open to normally closed.

Accordingly, in response to the print fluid supply cartridge 720 being removed from the key assembly 719, fluidic transmission of print fluid to a print fluid reservoir of the imaging device is to cease. For example, the actuation of the magnetically actuated valve 712 from open to normally closed can stop fluidic transmission of print fluid.

Although the actuation of the valve 712 from normally closed to open and/or from open to normally closed is described above as being accomplished magnetically, examples of the disclosure are not so limited. For example, the valve can be any other type of valve such that in response to the plunger 702 being moved from the first position to the second position by the key of the print fluid supply cartridge 720, the valve can be actuated from normally closed to open (e.g., by a lever, etc.), and in response to the plunger being moved from the second position to the first position, the valve can be actuated from open to normally closed.

An apparatus having valves actuated by magnets, according to the disclosure, can allow for actuation of a magnetically actuated valve under certain conditions. For example, the magnetically actuated valve can be actuated when in the presence of a magnet included in a cavity of a plunger. The magnet can be adjacent to the magnetically actuated valve when the plunger is moved from a first position to a second position. Further, the plunger may be depressed by a key having a shape that is to be inserted into a complimentarily shaped aperture. Accordingly, other mechanisms such as a dowel, pin, poker, a user's finger, etc. may not depress the plunger, which can prevent unintentional depression of the plunger which can reduce instances of the valve being unintentionally actuated. This can prevent pressure loss in the imaging device, leaking of print fluid, etc.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a plunger comprising a cavity;
a bezel comprising an aperture having a particular shape;
a magnet located in the cavity of the plunger; and
a magnetically actuated valve connected to the bezel;
wherein in response to the plunger being moved by a key having a shape corresponding to the particular shape of the aperture of the bezel, the magnet is to cause the magnetically actuated valve to actuate.

2. The apparatus of claim 1, wherein the plunger comprises a plurality of surfaces including a key surface.

3. The apparatus of claim 2, wherein:
the bezel covers the plurality of surfaces of the plunger; and
the particular shape of the aperture of the bezel exposes a portion of the key surface of the plunger.

4. The apparatus of claim 1, wherein the magnetically actuated valve is normally closed.

5. The apparatus of claim 4, wherein actuation of the magnetically actuated valve is to cause the valve to actuate from normally closed to open.

6. An apparatus, comprising:
a plunger in a first position, wherein the plunger comprises a plurality of surfaces including a key surface, and a cavity;
a bezel comprising an aperture having a particular shape; wherein the particular shape of the aperture of the bezel exposes a portion of the key surface of the plunger;
a magnet located in the cavity of the plunger; and
a magnetically actuated valve, wherein the magnetically actuated valve is normally closed;
wherein in response to the plunger being moved from the first position to a second position by a key having a shape corresponding to the particular shape of the aperture of the bezel, the magnet is to cause the magnetically actuated valve to actuate from normally closed to open.

7. The apparatus of claim 6, wherein the cavity of the plunger is oriented such that the magnet is to be located adjacent to the magnetically actuated valve in response to the plunger being in the second position.

8. The apparatus of claim 6, wherein the apparatus further comprises a spring.

9. The apparatus of claim 8, wherein the spring is connected to the plunger such that the plunger is normally in the first position.

10. The apparatus of claim 8, wherein the spring is to be in a compressed state in response to the plunger being in the second position.

11. A system, comprising:
a key assembly comprising:
a plunger connected to a spring, the plunger comprising:
a plurality of surfaces including a key surface; and
a cavity;
a bezel comprising an aperture having a particular shape, wherein the particular shape of the bezel exposes a portion of the key surface of the plunger;
a magnet located in the cavity of the plunger; and
a magnetically actuated valve; and
a print fluid supply cartridge, wherein:
the print fluid supply cartridge includes a key having a shape corresponding to the shape of the aperture of the bezel; and
in response to the plunger being moved from a first position to a second position by the key, the magnet is to be positioned adjacent to the magnetically actuated valve to cause the magnetically actuated valve to actuate from normally closed to open.

12. The system of claim 11, wherein the print fluid supply cartridge is to interface with the key assembly such that the key is to be inserted through the aperture to contact the key surface of the plunger to cause the plunger to be moved from the first position to the second position.

13. The system of claim 11, wherein in response to the valve being open, print fluid is to be supplied from the print fluid supply cartridge to a print fluid reservoir via the magnetically actuated valve.

14. The system of claim 11, wherein in response to the print fluid supply cartridge being removed from the key assembly, the spring is to decompress to cause the plunger to move from the second position to the first position.

15. The system of claim 14, wherein in response to the print fluid supply cartridge being removed from the key assembly, fluidic transmission of print fluid to a print fluid reservoir is to cease based on the magnetically actuated valve actuating from open to normally closed.
